(19) United States
(12) Patent Application Publication
(10) Pub. No.: US 2024/0001956 A1
(43) Pub. Date: Jan. 4, 2024

(54) APPARATUS AND METHOD FOR PROCESSING SENSOR SINGNAL, AND VEHICLE HAVING THE SAME

(71) Applicant: HL MANDO Corporation, Pyeongtaek (KR)

(72) Inventor: Daehun Hwang, Seongnam (KR)

(21) Appl. No.: 18/297,890

(22) Filed: Apr. 10, 2023

(30) Foreign Application Priority Data
Jun. 30, 2022 (KR) 10-2022-0080244

(51) Int. Cl. B60W 60/00; B60W 30/00

(52) U.S. Cl. CPC B60W 60/001; B60W 30/00; B60W 2554/00; B60W 2422/00

(57) ABSTRACT

The present disclosure relates to an apparatus and method for processing a sensor signal, and a vehicle having the same. The apparatus according to an embodiment of the present disclosure is an apparatus applied to a vehicle, the apparatus comprising a plurality of sensors of a same type configured for detecting a same detection target object and generating a plurality of sensor signals with values; and a controller configured for determining usable sensor signals from among the plurality of sensor signals by using value differences among the sensor signals.

### BACKGROUND

### Field of the Invention

The present disclosure relates to a technology for processing sensor signals in a vehicle, and more particularly, to a technology for processing signals of a plurality of sensors detecting the same detection target object in a vehicle.

### Discussion of Related Art

Recently, as the autonomous driving technology is applied to vehicles, various sensor technologies have been employed in vehicles to secure driving safety. In particular, as the number of sensors applied to vehicles increases rapidly, requirements for reliability as well as redundancy for sensor signals are increasing.

To this end, a plurality of sensors for detecting the same detection target object are applied in a vehicle. For example, a prior art has improved the redundancy and reliability of the sensor signals by applying three (3) sensors detecting the same detection target object.

However, in the prior art, when a failure occurs in at least one of those three (3) sensors, signals from the remaining two (2) or lesser number of sensors are used, thus making it difficult to achieve a high safety guarantee goal in autonomous driving.

Meanwhile, when a plurality of sensors for detecting the same detection target object are applied in a vehicle, a technology is needed for determining more easily, accurately, and efficiently whether or not each sensor is in a failure.

The foregoing is intended merely to aid in the understanding of the background of the present disclosure and is not intended to mean that the present disclosure falls within the purview of the related art that is already known to those skilled in the art.

### SUMMARY OF THE INVENTION

In order to solve the problems of the related art as described above, the present disclosure is directed to providing a technology for processing signals of a plurality of sensors detecting the same detection target object in a vehicle and processing the signals at a level capable of satisfying a high safety guarantee target.

In addition, the present disclosure is directed to providing a technology for processing corresponding sensor signals to more easily, accurately and efficiently determine whether a plurality of sensors for detecting the same detection target object in a vehicle are out of order.

However, the technical problems to be achieved in the present disclosure are not limited to the technical problems mentioned above, and other technical problems not mentioned will be clearly understood by those of ordinary skill in the art from the following description.

An apparatus according to an embodiment of the present disclosure is an apparatus applied to a vehicle, the apparatus comprising a plurality of sensors of a same type, each of the plurality of sensors configured for detecting a same detection target object and generating a sensor signal with a value, thereby generating a plurality of sensor signals; and a controller configured for determining usable sensor signals from among the plurality of sensor signals by using value differences among the plurality of sensor signals.

The controller may determine that a plurality of usable sensor signals are the usable or determine that all sensor signals are unusable.

The controller may perform control of the vehicle by using an average value of the usable sensor signals as a representative sensor value.

n sensors may be provided (where n is a natural number of 4 or more).

The controller performs a first operation, and the first operation comprises: selecting pairs of two (2) different sensor signals from the plurality of sensor signals, determining whether a value difference in each of the pairs of the selected two (2) sensor signals in an error range, determining a sensor signal overlapping in all pairs having a value difference in the error range as an error sensor signal, and excluding the error sensor signal from the usable sensor signals.

Wherein the plurality of sensor signals excluding the error sensor signal is defined as remaining sensor signals, the controller repeatedly performs a second operation if the number of the remaining sensor signals is three (3) or more, and the second operation may be an operation comprising: selecting pairs of two (2) different sensor signals from the remaining sensor signals, determining whether a value difference in each of the pairs of the selected two (2) sensor signals is in the error range, determining, as an error sensor signal, a sensor signal overlapping in all pairs having a value difference in the error range, and excluding error sensor signal from the usable sensor signals.

The controller performs a third operation if the number of the remaining sensor signals excluding the error sensor signal is two (2), and the third operation may be an operation comprising: determining a value difference for the two (2) remaining sensor signals, excluding all the two (2) remaining sensor signals from the usable sensor signals if the value difference is in the error range, and alternatively, including all the two (2) remaining sensor signals to the usable sensor signals if the value difference of the two (2) remaining sensor signals is not in the error range.

The controller may perform a function control of an advanced driver assistance system (ADAS) or autonomous driving of the vehicle by using the usable sensor signals.

The ADAS may include at least one of an autonomous emergency braking system, a smart parking assistance system (SPAS), a blind spot detection (BSD) system, an adaptive cruise control (ACC) system, a lane departure warning system (LDWS), a lane keeping assistance system (LKAS), or a lane change assistance system (LCAS).

The plurality of sensors may be mounted to the same site in the vehicle.

A method according to an embodiment of the present disclosure is a method performed by an apparatus of a vehicle, the method comprising: receiving sensor signals with values generated by a plurality of sensors of a same type, each of the plurality of sensors configured for detecting a same detection target object and generating each of the sensor signals; and determining usable sensor signals from among the plurality of sensor signals by using value differences among the plurality of signals.

The step of determining the usable sensor signals may include determining a plurality of usable sensor signals are usable or determining that all sensor signals are unusable.

The method according to an embodiment of the present disclosure may further include performing a control of the vehicle by using an average value of the usable sensor signals as a representative sensor value.

n sensors may be provided (where n is a natural number of 4 or more).

The step of determining the usable sensor signals further includes a first operation, and the first operation may include selecting pairs of two (2) different sensor signals from the plurality of sensor signals; determining whether a value difference in each of the pairs of the selected two (2) sensor signals is in an error range; and determining, as an error signal, a sensor signal overlapping in all pairs having a value difference in the error range, and excluding the error sensor signal from the usable sensor signals.

Wherein the plurality of sensor signals excluding the error sensor signal is defined as remaining sensor signals, the step of determining the usable sensor signals further includes repeatedly performing a second operation if the number of the remaining sensor signals is three (3) or more, and the second operation may include selecting pairs of two (2) different sensor signals from the remaining sensor signals; determining whether a value difference in each of the pairs of the selected two (2) sensor signals is in the error range; and determining, as an error sensor, a sensor signal overlapping in all pairs having a value difference in the error range, and excluding the error sensor signal from the usable sensor signals.

The step of the determining the usable sensor signals further includes performing a third operation if the number of the remaining sensor signals excluding the error signal is two (2), and the third operation may include determining a value difference for the two (2) remaining sensor signals; excluding all the two (2) remaining sensor signals from the usable sensor signals if the value difference of the two (2) remaining sensor signals is in the error range; and alternatively, including all the two (2) remaining sensor signals to the usable sensor signals if the value difference of the two (2) remaining sensor signals is not in the error range.

A vehicle according to an embodiment of the present disclosure is a vehicle comprising an apparatus for processing a sensor signal, the apparatus including a plurality of sensors of a same type, each of the plurality of sensors configued for detecting a same detection target object and generating a sensor signal with a value, thereby generating a plurality of sensor signals; and a controller configured for determining usable sensor signals from among the plurality of sensor signals by using value differences of the plurality of sensor signals.

The vehicle includes an advanced driver assistance system (ADAS) or is an autonomous vehicle, and the controller may perform a function control of ADAS or autonomous driving by using the usable sensor signals.

The present disclosure configured as described above has the advantage of determining a plurality of usable sensor signals by using value differences among a plurality of sensors detecting the same detection target object in a vehicle, and processing the plurality of usable sensor signals to determine a representative sensor value in a plurality of sensor signals, so that a high safety guarantee target can be satisfied.

In addition, the present disclosure has the advantage of determining whether or not each sensor is faulty by processing each sensor signal of a plurality of sensors detecting the same detection target object in a vehicle, so that each sensor can be easily, accurately, and efficiently determined.

In addition, the present disclosure uses 4 or more sensors detecting the same detection target object in a vehicle, so that a higher reliability can be guaranteed and a high safety guarantee target can be achieved than the related art using 3 sensors, and thus the present disclosure can also be applied to an autonomous vehicle.

However, the effects of the present disclosure are not limited to those mentioned above, and other effects not mentioned will be clearly understood by those of ordinary skill in the art from the following description.

### BRIEF DESCRIPTION OF THE DRAWINGS

FIG. 1 is a block diagram of an apparatus according to an embodiment of the present disclosure.

FIG. 2 illustrates a flowchart of a processing method according to an embodiment of the present disclosure.

FIG. 3 illustrates a more detailed flowchart of S200.

FIG. 4 illustrates various examples of error types and error sensor signals for all 4 sensor signals S₁, . . . S₄.

FIG. 5 illustrates a more detailed flowchart of S240.

FIG. 6 illustrates various examples of error types and error sensor signals for three (3) remaining sensor signals S₁, S₂, S₃, excluding one (1) sensor signal S₄ that is determined as an error sensor signal.

FIG. 7 illustrates a more detailed flowchart of S250.

FIG. 8 illustrates various examples of error types and error sensor signals for two (2) remaining sensor signals S₁ and S₂, excluding two (2) sensor signals S₄ and S₃ that are determined as error sensor signals.

### DETAILED DESCRIPTION OF EXEMPLARY EMBODIMENTS

The above-mentioned objects, means, and effects thereof of the present disclosure will become more apparent from the following detailed description in relation to the accompanying drawings, and accordingly, those skilled in the art to which the present disclosure belongs will be able to practice easily the technical idea of the present disclosure. In addition, in describing the present disclosure, when a detailed description of known function and configuration may obscure the subject matter of the present disclosure, the detailed description of such known function and configuration will be omitted.

The terms used in this specification are used for the purpose of describing embodiments of the present disclosure and are not intended to limit the present disclosure. In this specification, the singular forms “a,”, “an,” and “the” and similar references in the context of describing embodiments are to be construed to cover both the singular and the plural, unless otherwise indicated herein or clearly contradicted by context. In this specification, terms such as “include”, “comprise”, “provide” or “have” specifies the presence of stated features, numbers, steps, operations, elements, components, and/or combinations thereof, not to exclude the presence or possibility of adding of one or more of other features, numbers, steps, operations, elements, components, and/or combinations thereof.

In this specification, terms such as “or” and “at least one”, and the like may represent one of the words listed together or a combination of two or more thereof. For example, “A or B” and “at least one of A and B” may include only one of A or B, or may also include both A and B.

In this specification, descriptions according to “for example”, etc. may not exactly match the information presented, such as recited properties, variables, or values, and effects such as modifications, including tolerances, measurement errors, limits of measurement accuracy, and other commonly known factors should not limit the modes for carrying out the invention according to the various exemplary embodiments of the present disclosure.

In this specification, when an element is described as being “connected” or “linked” to another element, it will be understood that it may be directly or indirectly connected or linked to the other element, allowing a potential intervening element. On the other hand, when an element is referred to as being “directly connected” or “directly linked” to another element, it will be understood that there are no intervening elements present.

In this specification, when an element is described as being “on” or “adjacent to” another element, it will be understood that it may be directly or indirectly “on” or “connected to” the other element, allowing a potential intervening element. On the other hand, when an element is described as being “directly on” or “directly adjacent to” another element, it will be understood that there are no intervening elements present. Other expressions describing the relationship between the elements, for example, ‘between’ and ‘directly between’, and the like should be construed similarly.

In this specification, terms such as “first” and “second” may be used to describe multiple elements, however, those multiple elements should not be limited by the terms “first” and “second”. In addition, the above terms “first” and “second” should not be construed as limiting the order of each element, and may be used for the purpose of distinguishing one element from another. For example, a “first element” may be named as a “second element” and similarly, a “second element” may also be named as a “first element.”

Unless otherwise defined, all terms used in this specification are used with meanings commonly understood by those of ordinary skill in the art to which the present disclosure belongs. In addition, terms defined in a commonly used dictionary are not interpreted ideally or excessively unless explicitly and specifically defined.

Hereinafter, preferred embodiments according to the present disclosure will be described in detail with reference to the accompanying drawings. However, it should be noted that the present disclosure is not limited thereto, and may include all of modifications, equivalents or substitutions within the spirit and scope of the present disclosure. It is also noted that like elements are denoted in the drawings by like reference symbols as whenever possible. Further, the detailed description of known functions and configurations in the drawings that may obscure the gist of the present disclosure will be omitted from the drawings. For the same reason, some of the elements in the drawings are exaggerated, omitted, or schematically illustrated.

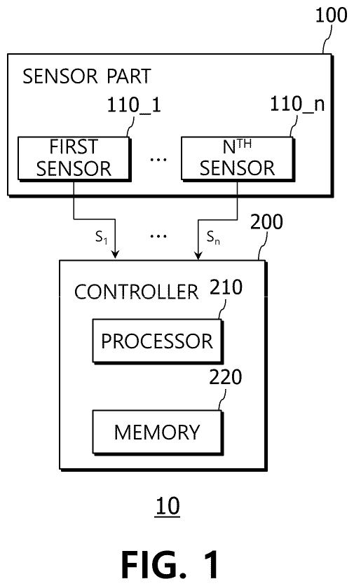

FIG. 1 is a block diagram of an apparatus according to an embodiment of the present disclosure.

An apparatus 10 according to an embodiment of the present disclosure is an apparatus applied to a vehicle, and includes a sensor part 100 and a controller 200.

The sensor part 100 is configured to include n sensors 110_1, . . . 110_n. Here, n is a natural number of two (2) or more, preferably a natural number of three (3) or more, and most preferably a natural number of four (4) or more. Accordingly, the n sensors 110_1, . . . 110_n are a plurality, preferably a natural number of three (3) or more, and most preferably a natural number of four (4) or more.

The n sensors 110_1, . . . 110_n are the same type of sensors that detect the same detection target object of the vehicle. That is, the plurality of sensors 110_1, . . . 110_n may be mounted to the same site in the vehicle, or may be mounted in a region very close to each other, and detect the same type of object. According to an embodiment, the n sensors 110_1, . . . 110_n may be identical sensors to each other performing a same detection function with respect the same detection target object. The k^{th} sensor signal generated by the k^{th} sensor 110_k (where k is one of natural numbers from 1 to n) is referred to as “Sₖ”.

Each of the sensors 110_1, . . . , 110_n may generate a sensor signal with a value indicating a result of sensing the detection target object.

As described above, since the plurality of sensors 110_1, . . . 110_n are used for the same detection target object and generates sensor signals S₁, . . . Sₙ respectively, the present disclosure may provide redundancy for the sensor signal of the sensor part 100.

The sensors 110_1, . . . 110_n may be sensors for various detection target objects. For example, the sensors 110_1, . . . 110_n may be a position sensor (for example, a motor position sensor or the like), a speed sensor (for example, a vehicle speed sensor or the like), a torque sensor, an angle sensor (for example, a steering angle sensor or the like), an illuminance sensor, a rainfall sensor, a snowfall sensor, a camera sensor, a radar sensor, a lidar sensor, a pressure sensor, a hall sensor, or a flow sensor. The sensors 110_1, . . . 110_n may be any type of sensor that may be installed in a vehicle to detect a physical amount or a change thereof. However, the sensors 110_1, . . . 110_n are not limited thereto and may include any type of sensors.

The controller 200 is a component that processes each sensor signal S₁, . . . Sₙ generated by the sensors 110_1, . . . 110_n to control a function necessary in the vehicle. The controller 200 may be an “electronic control unit (ECU)”. The controller 200 may include a processor 210 and a memory 220.

The memory 220 may store a program for operation of the processor 210 and various kinds of data related to determining a failure of the sensors 110_1, . . . 110_n. According to an embodiment, the memory 220 may store a program related to processing methods to be described later.

According to an embodiment, the memory 220 may include a volatile memory such as a DRAM or an SRAM, or may include a non-volatile memory such as a PRAM, an MRAM, a ReRAM, a Read Only Memory (ROM), an Erasable Programmable Read Only Memory (EPROM), a flash memory, or the like, or may include a hard disk drive (HDD), a solid state drive (SSD), or the like, but is not limited thereto.

The processor 210 performs various processing or control using information stored in the memory 220. For example, the processor 210 may control processing of each of the sensor signals S₁, . . . Sₙ, determining any failure of the sensors 110_1, . . . 110_n, performing a function necessary in a vehicle using the sensor signals from the sensors in the sensor part 110 determined to be normal, or the like. That is, the processor 210 is responsible for various processing or control performed by the controller 200, and may control the performance of the processing methods to be described later.

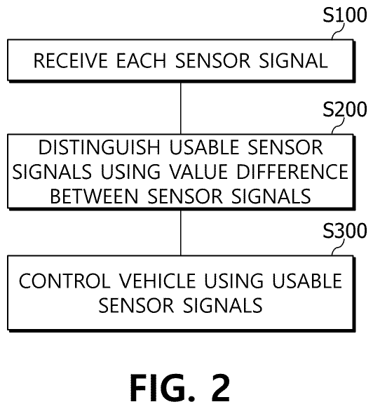

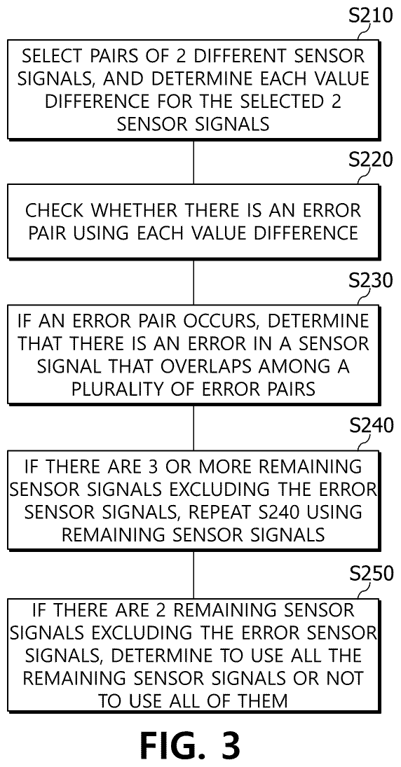

FIG. 2 illustrates a flowchart of a processing method according to an embodiment of the present disclosure, and FIG. 3 illustrates a more detailed flowchart of S200.

A processing method (hereinafter, referred to as the “present processing method”) according to an embodiment of the present disclosure is performed under the control of the controller 200, and includes a function (hereinafter, referred to as a “first function”) that determines whether or not each of the sensor 110_1, . . . 110_n is normal or in a failure by processing each of the sensor signals S₁, . . . Sₙ. To this end, the present processing method may include S100 and S200, as illustrated in FIG. 2. In other words, in S100 and S200 the first function may be performed.

In addition, the present processing method according to an embodiment may further include a function (hereinafter, referred to as a “second function”) that performs a function necessary in a vehicle using a usable sensor signal (i.e., a sensor signal determined to be normal) according to a result of the first function. To this end, the present processing method may further include S300. In other words, in S300 the second function may be performed.

Meanwhile, for convenience of description, the present processing method will be described assuming that n is equal four (4). However, the present disclosure is not limited thereto, and the corresponding description is applicable to a case where n is larger than 4 under the same principle.

First, in S100, the controller 200 receives each sensor signal S₁, . . . Sₙ from a plurality of sensors 110_1, . . . 110_n. Each sensor signal S₁, . . . Sₙ, may include a value indicating a result of the detection by each of the sensor 110_1, . . . 110_n.

Next, in S200, the controller 200 distinguishes and/or determine a usable sensor signal among the sensor signals S₁, . . . Sₙ by using values differences between the received sensor signals S₁, . . . Sₙ. That is, the controller 200 may determine a normal sensor signal and an error sensor signal, respectively, using a plurality of value differences.

As illustrated in FIG. 3, the S200 according to an embodiment may include S210 to S230. Operations from S210 to S230 may be referred to as a “first operation.” The S200 may further include S240 or S250. The S240 may be referred to as a “second operation” and the S250 may be referred to as a “third operation.”

Specifically, in S210, the controller 200 selects all possible pairs of two (2) different sensor signals from the received sensor signals S₁, . . . Sₙ, and determines a value difference of the selected two (2) sensor signals in each of the all pairs.

For example, if n is equal to four (4), all pairs of two (2) different sensor signals are selected for S₁, . . . S₄, and value differences of the selected two (2) sensor signals in each of all those pairs are determined. In this case, as described in Table 1 below, for S₁, . . . S₄, there are six (6) pairs in total, and accordingly, six (6) value differences D₁, . . . D₆ may be determined from those six (6) pairs, respectively.

TABLE 1

| Value Difference Pair | Value Difference (D) |
|---|---|
| first pair | D₁ = S₁ − S₂ |
| second pair | D₂ = S₁ − S₃ |
| third pair | D₃ = S₁ − S₄ |
| fourth pair | D₄ = S₂ − S₃ |
| fifth pair | D₅ = S₂ − S₄ |
| sixth pair | D₆ = S₃ − S₄ |

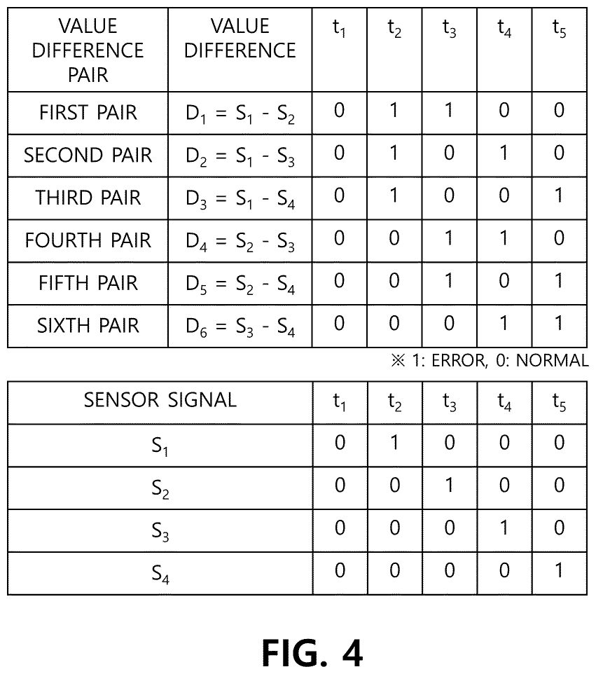

FIG. 4 illustrates various examples of value differences and error sensor signals for all four (4) sensor signals S₁, . . . S₄ based on the pairs and the value differences of Table 1.

Next, in S220, the controller 200 checks and determine whether each pair is a normal pair or an error pair. Specifically, the controller 200 determines whether the value difference of each pair (i.e., an absolute value of the difference between the value of one signal in the pair and the value of the other signal in the pair) is within a normal range or within an error range. According to an embodiment, the controller 200 may determine that the value difference is within the normal range if the value difference is within a predetermined range and may determine that the value difference is within the error range if the value difference is not within the predetermined range. According to an embodiment, the controller 200 may determine that a pair is a normal pair if the value difference is within a normal range and that a pair is an error pair if the value difference is within an error range.

Here, when a pair is determined as an error pair, a plurality of error types occur due to the nature and characteristics of the multiple pairs selected in S210 as shown in Table 1. It is because if there is a sensor in error (for example, sensor 110_1), the sensor signal S₁ from the sensor in error 110_1 is paired with multiple other sensor signals such as sensor signals S₂, S₃, and S₄ as shown in Table 1, and all those pairs having S₁ may be determined as error pairs.

For example, referring to FIG. 4, as in the case of t₁, when all six (6) value differences D₁, . . . D₆ are within the normal range, the controller 200 may determine that all four (4) sensor signals S₁, . . . S₄ are normal, and accordingly, all the sensors 100_1, . . . 100_4 are determined normal.

In the table at the top in FIG. 4, when a value difference of a pair is within the normal range, the pair and the value difference Dₖ is denoted as “0”, indicating “NORMAL” and when the value difference of a pair is within the error range, the pair and the value difference Dₖ is denoted as “1”, indicating “ERROR”. In the table at the bottom in FIG. 4, when a signal is determined as normal, it is denoted as “0” indicating “NORMAL” and when a signal is determined as error, it is denoted as “1” indicating “ERROR”. This applies to Tables 6 and 8 as well.

However, as in the case of any one of t₂ to t₅, a plurality of error pairs may occur among the six (6) value differences D₁, . . . D₆. For example, in the case of t₂, D₁, D₂, and D₃ are indicated as error pairs, and in the case of t₃, D₁, D₄, and D₅ are indicated as error pairs. In addition, in the case of t₄, D₂, D₄, and D₆ are indicted as error pairs, and in the case of t₅, D₃, D₅, and D₆ are indicated as error pairs.

Next, S230, S240, and S250 may be performed by the controller 200 only if an error pair occurred in S220. In other words, S230, S240, and S250 may be performed only if any one of the pairs is determined as an error pair in S220.

In S230, if an error pair occurs in S220, the controller 200 selects a sensor signal that overlaps in a plurality of error pairs, and determines that there is an error in the selected sensor signal. That is, the controller 200 may select a sensor signal 110_k that is overlaps in (i.e., is found in) all of the error pairs and may determine that the selected sensor signal is an error sensor signal. Thereby, the controller 200 may determine that a failure has occurred in the sensor 110_k that generates the selected sensor signal.

For example, referring to FIG. 4, in the case of t₂, a sensor signal included and overlapping in all of the error pairs of D₁, D₂, and D₃ is S₁. Accordingly, the controller 200 may determine that there is an error in the sensor signal S₁ and a failure has occurred in the first sensor 100_1 that generated S₁.

For another example, in the case of t₃, a sensor signal included in and overlapping in all of the error pairs of D₁, D₄, and D₅ is S₂. Accordingly, the controller 200 may determine that there is an error in sensor signal S₂ and a failure has occurred in the second sensor 100_2 that generated S₂.

For another example, in the case of t₄, a sensor signal included and overlapping in all of the error pairs of D₂, D₄, and D₆ is S₃. Accordingly, the controller 200 may determine that there is an error in sensor signal S₃ and a failure has occurred in the third sensor 100_3 that generated S₃.

For still another example, in the case of t₅, a sensor signal included and overlapping in all of the error pairs of D₃, D₅, and D₆ is S₄. Accordingly, the controller 200 may determine that there is an error in sensor signal S₄ and a failure has occurred in the fourth sensor 100_4 that generated S₄.

Meanwhile, according to an embodiment, S210 to S230 may be performed using the sensor signals S₁, . . . Sₙ generated at the same time. The generated sensor signals may include a time data indicating the time of generation of the respective sensor signals. That is, while receiving each sensor signals S₁, . . . Sₙ the controller 200 may also identify a detection time of the respective sensor signals. Since the time data of corresponding detection is included in each of the sensor signals S₁, . . . Sₙ, the controller 200 may identify a time of corresponding detection by using such time data. Alternatively, the controller 200 may identify a corresponding detection time by checking a time at which each of the sensor signals S₁, . . . Sₙ is received by the controller 200 according to an embodiment. In other words, according to an embodiment, the controller 200 may consider that sensor signals received at the same time are generated at the same time and perform S210 to S230 using the sensor signals received at the same time.

In one process from S210 to S230, the controller 200 may determine an occurrence of an error of one (1) sensor signal at any one time moment (i.e., the first time moment). For the convenience of the description, sensor signals other than the error signal is referred to as remaining sensor signals. At a time moment after the first time moment, the controller 200 may check whether an error of another sensor signal occurs from among the remaining sensor signals. To this end, the controller 200 may additionally perform S240.

That is, in S240, the controller 200 may perform the similar processes described in S210 to S230 using the remaining sensor signals to determines which sensor signal has an error among the remaining sensor signals.

According to an embodiment, in S240 the remaining sensor signals received at a later time moment than the sensor signal used in S210 to S230. That is, if S210 to S230 are performed using the sensor signals generated at the first time moment, it may be preferable that S240 is performed using the remaining sensor signals generated at the second time moment (i.e., a time moment later than the first time moment).

In addition, according to an embodiment, S240 may be repeatedly performed a plurality of times. In the repeatedly-performed subsequent S240, the remaining sensor signals received later in time than the sensor signals used in the previous S240. That is, if the previous S240 is performed using the remaining sensor signals generated at the second time moment, it may be preferable that the subsequent S240 is performed using the remaining sensor signals generated at the third time moment (i.e., a time moment later than the second time moment).

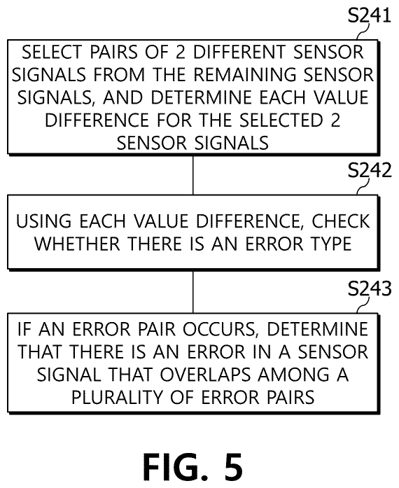

FIG. 5 illustrates a more detailed flowchart of S240.

As illustrated in FIG. 5, S240 may include S241 to S243. S241 is a process corresponding to or similar to S210, S242 is a process corresponding to or similar to S220, and S243 is a process corresponding to or similar to S230. This S240 may be repeatedly performed if there are at least three (3) remaining sensor signals (i.e., if the number of pairs selected from the remaining control signals is three (3) or more).

Specifically, in S241, the controller 200 may select pairs of two (2) different sensor signals from the remaining sensor signals, and determines a value difference for each of the pairs.

For example, suppose that n is equal to four (4) and that an event corresponding to t₅ has occurred in S230 (i.e., suppose it is determined that an error has occurred in the fourth control signal S₄). Then, in S241 sensor signal S₄ is excluded and pairs of two (2) different sensor signals are selected from the remaining sensor signals S₁, S₂, and S₃ and value differences for each pair of the selected two (2) sensor signals are determined. In other words, as described in Table 2 below, the controller 200 selects only three (3) difference value difference pairs (i.e., the first pair, the second pair, and the fourth pair) from S₁, S₂, and S₃, and accordingly, only three (3) value differences D₁, D₂, and D₄ are generated by the controller 200.

TABLE 2

| Value Difference Pair | Value Difference (D) |
|---|---|
| first pair | D₁ = S₁ − S₂ |
| second pair | D₂ = S₁ − S₃ |
| fourth pair | D₄ = S₂ − S₃ |

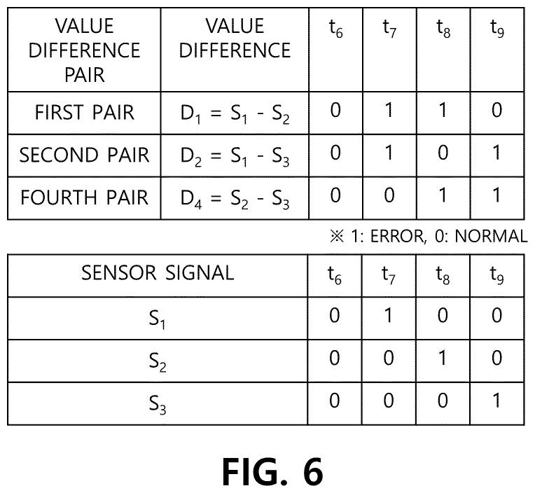

FIG. 6 illustrates various examples of value differences and error sensor signals for the three (3) remaining sensor signals S₁, S₂, S₃, excluding the sensor signal S₄ that is determined as an error sensor signal in S230. It is noted that for the convenience of consistency, the names of pairs remains the same as in Table 1. In other words, for example, the value difference between S₂ and S₃, is referred to as fourth pair and D₄ in Table 2, which is the same as in Table 1.

Next, in S242, the controller 200 checks and determine whether each pair is a normal pair or an error pair. Specifically, the controller 200 determines whether the value difference of each pair (i.e., an absolute value of the difference between the value of one signal in the pair and the value of the other signal in the pair) is within a normal range or within an error range. According to an embodiment, the controller 200 may determine that the value difference is within the normal range if the value difference is within a predetermined range and may determine that the value difference is within the error range if the value difference is not within the predetermined range. According to an embodiment, the controller 200 may determine that a pair is a normal pair if the value difference is within a normal range and that a pair is an error pair if the value difference is within an error range.

Here, when a pair is determined as an error pair and the number of remaining sensor signals is three (3) or more, a plurality of error types occur due to the nature and characteristics of the multiple pairs selected in S241 as shown in Table 2.

For example, referring to FIG. 6, as in the case of t₆, when all three (3) value differences D₁, D₂, and D₄ are within the normal range, the controller 200 may determine that all four (4) sensor signals S₁, S₂, and S₄ are normal, and accordingly, the remaining sensors 100_1, 100_2, and 100_4 are all determined normal. In this case, it is finally determined that there is an error only in S₄, which was previously determined as an error signal in S230.

However, as in the case of any one of t₇ to t₉, a plurality of error pairs may occur among the three (3) value differences D₁, D₂, and D₄. For example, in the case of t₇, D₁ and D₂ are indicated as error pairs, in the case of t₈, D₁ and D₄ are indicated as error pairs, and in the case of t₉, D₂ and D₄ are indicated as error pairs.

Next, S243 may be performed by the controller 200 only if an error pair occurred in S242. In other words, S243 may be performed only if any one of the pairs is determined as an error pair in S242.

In S243, if an error pair occurs in S242, the controller 200 selects a sensor signal that overlaps in a plurality of error pairs, and determines that there is an error in the selected sensor signal. That is, the controller 200 may select a sensor signal 110_j that is overlaps in (i.e., is found sin) all of the error pairs and may determine that the selected sensor signal is an error sensor signal. Thereby, the controller 200 may determine that a failure has occurred in the sensor 110_j that generates the selected sensor signal.

For example, referring to FIG. 6, in the case of t₇, a sensor signal included and overlapping in all of the error pairs of D₁ and D₂ is S₁. Accordingly, the controller 200 may determine that there is an error in sensor signal S₁ and a failure has occurred in the first sensor 100_1 that generated S₁. That is, in addition to sensor signal S₄ which was determined as an error in S230, sensor signal S₁ is additionally determined as an error in S243.

For another example, in the case of t₈, a sensor signal included and overlapping in all of the error pairs of D₁ and D₄ is S₂. Accordingly, the controller 200 may determine that there is an error in sensor signal S₂ and a failure has occurred in the second sensor 100_2 that generated S₂. That is, in addition to sensor signal S₄ which was determined as an error in S230, sensor signal S₂ is additionally determined as an error in S243.

For still another example, in the case of t₉, a sensor signal included and overlapping in all of the error pairs of D₂ and D₄ is S₃. Accordingly, the controller 200 may determine that there is an error in sensor signal S₃ and a failure has occurred in the third sensor 100_3 that generated S₃. That is, in addition to sensor signal S₄ which was determined as an error in S230, sensor signal S₃ is additionally determined as an error in S243.

Meanwhile, as previously described, S241 to S243 may be performed using the remaining sensor signals generated at the same time.

However, in one-time performance of S240 (i.e., in one cycle from S241 to S243), the controller 200 may determine an occurrence of an error for one (1) sensor signal among the remaining sensor signals at any one time moment (i.e., the second time moment). After the process of S240, if there are still three (3) or more remaining sensor signals left excluding the error sensor signal determined in S240 (that is, if the number of pairs that may be selected from the remaining sensor signals is three (3) or more), the above-described S240 (i.e., S241 to S243) may be repeatedly performed.

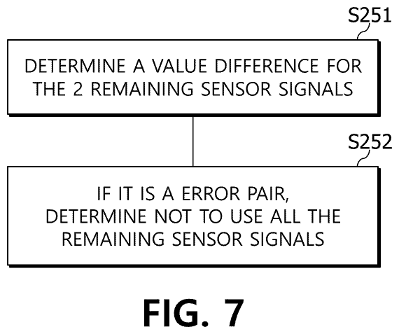

FIG. 7 illustrates a more detailed flowchart of S250.

When there are only two (2) remaining sensor signals left excluding all the error sensor signals (that is, if the number of pair that may be selected from the remaining control signals is only one (1)), the controller 200 may additionally perform S250.

According to an embodiment, in S250, the controller 200 may determine to use all of the two (2) remaining sensor signals or not to use all of them. As illustrated in FIG. 7, S250 includes S251 and S252.

Specifically, in S251, the controller 200 determines a value difference for the two (2) remaining sensor signals.

For example, suppose that n is equal to four (4), and that in S230 an event corresponding to the case t₅ has occurred at the first time moment (i.e., it is determined that an error has occurred in the fourth sensor signal S₄ at the first time moment). Also, suppose that in S240 an event corresponding to the case t₉ has occurred at the second time moment (i.e., it is determined that an error has occurred in the third sensor signal S₃ at the second time moment). Then, in S250, a value difference for the remaining S₁ and S₂ excluding S₄ and S₃ is determined. In this case, as described in Table 3 below, for sensor signal S₁ and sensor signal S₂, there is only one (1) pair in total (i.e., the first pair), and accordingly, one (1) value difference D₁ is obtained. According to an embodiment, S250 may be performed at a third time moment or may be performed using sensor signals generated or received at a third time moment, which is later in time than the second time moment.

TABLE 3

| Value Difference Pair | Value Difference (D) |
|---|---|
| first pair | D₁ = S₁ − S₂ |

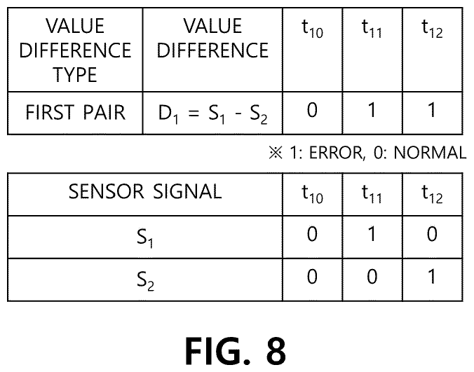

FIG. 8 illustrates various examples of value differences and error sensor signals for two (2) remaining sensor signals S₁ and S₂, excluding two (2) sensor signals S₄ and S₃ that are determined as error sensor signals at the first time moment in S230 and the second time moment in S240, respectively.

Next, in S252, the controller 200 checks and determine whether the pair is a normal pair or an error pair. Specifically, the controller 200 determines whether the value difference of the pair (i.e., an absolute value of the difference between the value of one signal in the pair and the value of the other signal in the pair) is within a normal range or within an error range by ways similar to the ways exemplarily described above.

For example, referring to FIG. 8, as in the case of t₁₀, when the value difference D₁ of the two (2) remaining sensor signals S₁ and S₂ is within the normal range, the controller 200 may determine that both of the two (2) sensor signals S₁ and S₂ are normal. Accordingly, the controller 200 may determine that both of the two (2) remaining sensors 100_1 and 100_2 are normal. In this case, the controller 200 may determine that only sensor signal S₄ previously determined in S230 and sensor signal S₃ previously determined in S240 are error sensor signals and that sensors 110_4 and 110_3 are in error.

However, as in the case of t₁₁ or t₁₂, the pair and its value difference D₁ of the two (2) remaining sensor signals S₁ and S₂ may be determined as an error pair. That is, as in the case of t₁₁ and t₁₂, D₁ may correspond to an error pair.

In S252, when the error pair occurred in S251, the controller 200 may determine that at least one of the two (2) remaining sensor signals has an error and determines to use neither of the two (2) remaining sensor signals. On the other hand, when the error pair did not occur in S251, the controller 200 may determine that both of the two (2) remaining sensor signals are normal and determines to use both of the two (2) remaining sensor signals.

Meanwhile, in the above-described S200, the controller 200 may determine usable sensor signals from the entire sensor signals by excluding the sensor signals determined to have an error. According to an embodiment, the usable sensor signals may be defined as all senor signals other than the excluded sensor signals for being error.

Next, in S300, the controller 200 performs a second function that performs a function necessary for the vehicle by using the usable sensor signal (i.e., the sensor signal determined to be normal) according to a result of the first function (i.e., S200).

According to an embodiment, the number of sensor signals determined to be usable in S200 may be plural. That is, the number of sensors 100 that are determined to be normal in S200 may be plural. Accordingly, various control functions necessary for the vehicle may be performed by using the plurality of usable sensor signals (i.e., sensor signals of the plurality of normal sensors 100).

In particular, the controller 200 may determine an average value of the plurality of usable sensor signals as a representative sensor value of the corresponding sensor 100 and perform various control functions necessary for the vehicle by using the determined representative sensor value. For example, the controller 200 may perform various controls related to driving speed, driving direction, braking, display, etc. by using the representative sensor value, but the present disclosure is not limited thereto. For example, the second function may include changing a speed of the vehicle, changing a direction of the vehicle, controlling a brake, controlling a display, but is not limited thereto.

Meanwhile, the above-described apparatus 10 and the vehicle to which the present processing method is applied may be a vehicle having an Advanced Driver Assistance System (ADAS), or an autonomous vehicle.

Here, ADAS may mean various types of advanced driver assistance systems. For example, the ADAS may include, but is not limited to, an autonomous emergency braking system, a smart parking assistance system (SPAS), a blind spot detection (BSD) system, an adaptive cruise control (ACC) system, a lane departure warning system (LDWS), a lane keeping assistance system (LKAS), a lane change assistance system (LCAS), and the like.

In particular, the above-described apparatus 10 and the present processing method may be used for controlling the function of the ADAS or the autonomous driving in a vehicle. That is, the controller 200 may perform the function control of the ADAS or the autonomous driving of the vehicle using the usable sensor signal or using the representative sensor value of the usable sensors.

In the detailed description of the present disclosure, although specific embodiments have been described, it is apparent that various modifications are possible without departing from the scope of the present disclosure. Therefore, the scope of the present disclosure is not limited to the described embodiments, and should be defined by the following claims and their equivalents.

What is claimed is:

1. An apparatus applied to a vehicle, comprising:
a plurality of sensors of a same type, each of the plurality of sensors configured for detecting a same detection target object and generating a sensor signal with a value, thereby generating a plurality of sensor signals; and
a controller configured for determining usable sensor signals from among the plurality of sensor signals by using value differences among the plurality of sensor signals.

2. The apparatus of claim 1, wherein the controller configured to determine that a plurality of usable sensor signals are the usable or determines that all sensor signals are unusable.

3. The apparatus of claim 1, wherein the controller is configured to perform a control of the vehicle by using an average value of the usable sensor signals as a representative sensor value.

4. The apparatus of claim 1, wherein n sensors are provided (where n is a natural number of 4 or more).

5. The apparatus of claim 4,
wherein the controller performs a first operation, and
wherein the first operation is an operation comprising: selecting pairs of two (2) different sensor signals from the plurality of sensor signals, determining whether a value difference in each of the pairs of the selected two (2) sensor signals is in an error range, determining, as an error sensor signal, a sensor signal overlapping in all pairs having a value difference in the error range, and excluding the error sensor signal from the usable sensor signals.

6. The apparatus of claim 5,
wherein the plurality of sensor signals excluding the error sensor signal is defined as remaining sensor signals,
wherein the controller repeatedly performs a second operation if the number of the remaining sensor signals is three (3) or more, and
wherein the second operation is an operation comprising: selecting pairs of two (2) different sensor signals from the remaining sensor signals, determining whether a value difference in each of the pairs of the selected two (2) sensor signals is in the error range, determining, as an error sensor signal, a sensor signal overlapping in all pairs having a value difference in the error range, and excluding the error sensor signal from the usable sensor signals.

7. The apparatus of claim 5,
wherein the controller performs a third operation if the number of the remaining sensor signals excluding the error sensor signal is two (2), and
wherein the third operation is an operation comprising: determining a value difference for the two (2) remaining sensor signals, excluding all the two (2) remaining sensor signals from the usable sensor signals if the value difference of the two (2) remaining sensor signals is in the error range, and alternatively, including all the two (2) remaining sensor signals to the usable sensor signals if the value difference of the two (2) remaining sensor signals is not in the error range.

8. The apparatus of claim 1, wherein the controller performs a function control of an advanced driver assistance system (ADAS) or autonomous driving of the vehicle by using the usable sensor signals.

9. The apparatus of claim 8, wherein the ADAS comprises at least one of an autonomous emergency braking system, a smart parking assistance system (SPAS), a blind spot detection (BSD) system, an adaptive cruise control (ACC) system, a lane departure warning system (LDWS), a lane keeping assistance system (LKAS), or a lane change assistance system (LCAS).

10. The apparatus of claim 1, wherein the plurality of sensors are mounted to a same site in the vehicle.

11. A method performed by an apparatus of a vehicle, comprising:
receiving sensor signals with values generated by a plurality of sensors of a same type, each of the plurality of sensors configured for detecting a same detection target object and generating each of the sensor signals; and
determining usable sensor signals from among the plurality of sensor signals by using value differences among the plurality of sensor signals.

12. The method of claim 11, wherein the determining the usable sensor signals comprises determining that a plurality of usable sensor signals are the usable or determining that all sensor signals are unusable.

13. The method of claim 1, further comprising performing a control of the vehicle by using an average value of the usable sensor signals as a representative sensor value.

14. The method of claim 11, wherein n sensors are provided (where n is a natural number of 4 or more).

15. The method of claim 14,
wherein the determining the usable sensor signals further comprises a first operation, and
wherein the first operation comprises:
selecting pairs of two (2) different sensor signals from the plurality of sensor signals;
determining whether a value difference in each of the pairs of the selected 2 sensor signals is in an error range; and
determining, as an error signal, a sensor signal overlapping in all pairs having a value difference in the error range, and excluding the error sensor signal from the usable sensor signals.

16. The apparatus of claim 15,
wherein the plurality of sensor signals excluding the error sensor signal is defined as remaining sensor signals,
wherein the determining the usable sensor signals further comprises repeatedly performing a second operation if the number of the remaining sensor signals is three (3) or more, and
wherein the second operation comprises:
selecting pairs of two (2) different sensor signals from the remaining sensor signals;
determining whether a value difference in each of the pairs of the selected two (2) sensor signals is in the error range; and
determining, as an error sensor, a sensor signal overlapping in all pairs having a value difference in the error range, and excluding the error sensor signal from the usable sensor signals.

17. The apparatus of claim 15,
wherein the determining the usable sensor signals further comprises performing a third operation if the number of the remaining sensor signals excluding the error sensor signal is two (2), and
wherein the third operation comprises:
determining a value difference for the two (2) remaining sensor signals;
excluding all the two (2) remaining sensor signals from the usable sensor signals if the value difference of the two (2) remaining sensor signals is in the error range; and alternatively, including all the two (2) remaining sensor signals to the usable sensor signals if the value difference of the two (2) remaining sensor signals is not in the error range.

18. A vehicle comprising an apparatus for processing a sensor signal,
the apparatus comprising:
a plurality of sensors of a same type, each of the plurality of sensors configured for detecting a same detection target object and generating a sensor signal with a value, thereby generating a plurality of sensor signals; and
a controller configured for determining usable sensor signals from among the plurality of sensor signals by using value differences of the plurality of sensor signals.

19. The vehicle of claim 18,
wherein the vehicle comprises an advanced driver assistance system (ADAS) or is an autonomous vehicle, and
wherein the controller performs a function control of an advanced driver assistance system (ADAS) or autonomous driving by using the usable sensor signals.
